(19) United States
(12) Patent Application Publication
(10) Pub. No.: US 2007/0008121 A1
(43) Pub. Date: Jan. 11, 2007

(54) RFID disablement detection of tampering

(76) Inventor: Matt E. Hart, Lunenburg, MA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/149,819

(22) Filed: Jun. 9, 2005

(51) Int. Cl. G08B 21/00

(52) U.S. Cl. 340/540

(57) ABSTRACT

Radio Frequency identification (“RFID”) tags are affixed to objects in such a way as to reliably change state in response to a trigger event. The change in state of an RFID tag based on a trigger event is used to indicate a change in state of an object associated with the RFID tag. The state of an RFID tag can be remotely detected with an RFID reader. Thus, the change in state of the object associated with the RFID tag can also be remotely detected.

### FIELD OF THE INVENTION

The present invention relates generally to radio frequency identification tags.

### BACKGROUND

Product manufacturers and sellers use tamper detection methods and systems to make evident any unauthorized access to a product from the time it was originally packaged. For example, tamper-evident metal tops for pressurized glass bottles have a depressed button in the center that pops up after the bottle is opened. As another example, foil or plastic seals can indicate that a product has been opened if they are broken or missing.

Conventional methods of tamper detection rely on proactive visual inspection of the packaging of each item. In some cases, the integrity of the seals is difficult to inspect. In case of seals inside other packaging, the integrity of the seals can generally only be detected after the consumer purchases the product and opens the outer packaging. However, consumers may not be able to reliably perform this visual inspection prior to buying or using the product. In the case of a missing seal, the consumer may not notice the lack of the seal, thus creating a health or safety risk for the consumer. On the other hand, in order for product manufacturers or store personnel to conduct these safety checks using conventional methods, vast amounts of employee hours must be invested to visually inspect every seal. Moreover, because tampering could occur at any time while the product is on store shelves, these costly visual inspections need to be undertaken repeatedly and frequently to adequately guard against tampering since the last inspection.

### SUMMARY

Radio Frequency identification (“RFID”) tags are affixed to objects in such a way as to reliably change state in response to a triggering event. Thus, it can be determined if the triggering event has occurred without visually inspecting the product.

In one embodiment, an RFID tag is positioned across the seal of product packaging so that it reliably becomes disabled when the product is opened. When an RFID reader completes the next read of tags, the tag affixed to the opened product is not read. Thus, an RFID reader outputs an alert that identifies the disabled tag.

In another embodiment, an RFID tag is embedded in a tire so that it reliably becomes disabled when the tread wears down to the point that the tire needs to be replaced. When an RFID reader completes the next read of tags, the tag that has been disabled due to the thin tread is not read. Thus, an RFID reader outputs an alert indicating that the tire should be replaced.

The description in the specification is not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1A shows an RFID tag suitable for the present invention.

FIG. 1B shows the disablement of an RFID tag, according to one embodiment.

FIG. 1C shows the enablement of an RFID tag, according to one embodiment.

FIG. 2A shows the placement of an RFID tag on a bottle to detect if the cap has been removed, according to one embodiment of the present invention.

FIG. 2B shows the placement of an RFID tag on a CD case to detect if the CD case has been opened, according to one embodiment of the present invention.

FIG. 2C shows the placement of an RFID tag on a product box to detect if the box has been opened, according to one embodiment of the present invention.

FIG. 3 shows an RFID anti-tamper system, according to one embodiment of the present invention.

FIG. 4 shows an RFID tag embedded in a tire, according to another embodiment of the present invention.

FIG. 5 shows an RFID disablement detection system, according to one embodiment of the present invention.

FIG. 6 shows an RFID tag embedded in an envelope, according to one embodiment of the present invention.

FIG. 7 shows a sample method to detect RFID tag disablement, according to one embodiment of the present invention.

FIG. 8 shows system for determining how much liquid resides in a container using RFID tags, according to one embodiment of the present invention.

### DETAILED DESCRIPTION OF THE EMBODIMENTS

According to the present invention, the reliable disablement of an RFID tag based on a trigger event is used to indicate a change in state of an object, so as to provide a mechanism whereby the change in state of the object can be detected without direct visual examination. The state of an RFID tag, whether capable of transmitting a signal or disabled, can be remotely detected with an RFID reader. It is the ability to remotely detect the state of the RFID tag that allows the indication of the change in state of the object to be perceived without direct visual examination. The figures and the following description relate to particular embodiments of the present invention by way of illustration only. It should be noted that from the following discussion, alternative embodiments of the structures and methods disclosed herein will be readily recognized as viable alternatives that may be employed without departing from the principles of the claimed invention.

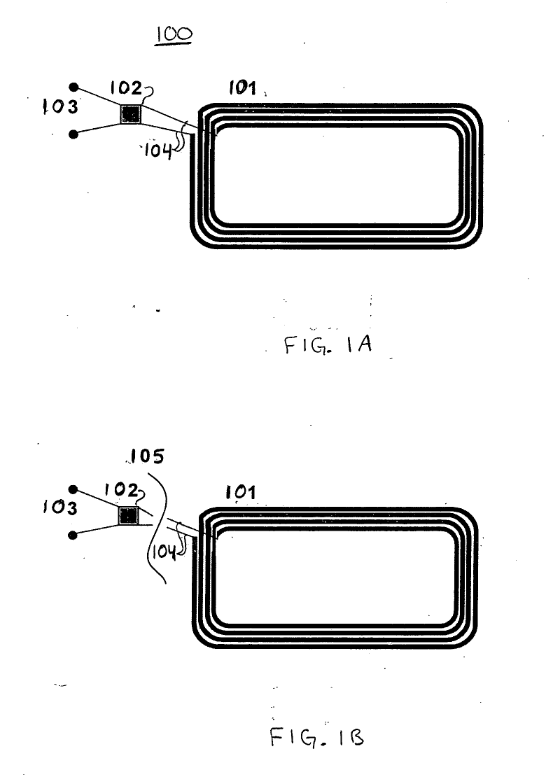

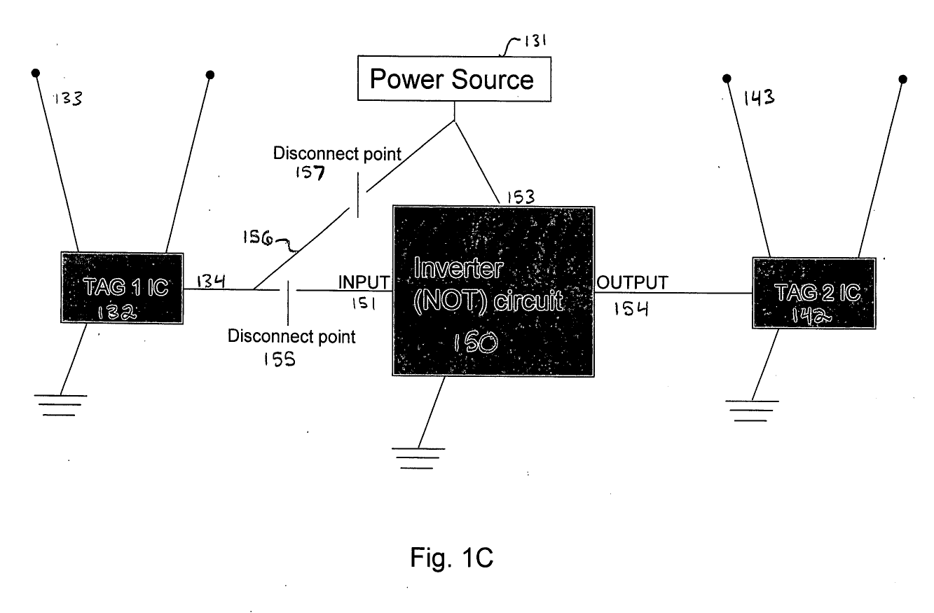

FIG. 1A shows one embodiment of an RFID tag 100 suitable for the present invention. In some embodiments, the RFID tag antenna 103 is designed to break in response to a trigger event. In this example, the RFID tag antenna 103 is a conductor capable of transmitting a signal. For example, RFID tag antenna 103 can comprise copper, gold, aluminum, or other metallic conductor, deposited on a material such as plastic or paper. Other conductors capable of transmitting a signal can also be used. In some embodiments, RFID tag antenna 103 is flexible. Alternatively, the RFID tag antenna 103 can be inflexible. An RFID tag antenna 103 typically operates at thicknesses of about 0.5 microns and higher. Copper foil becomes increasingly prone to tearing as the thickness falls below 9 microns. Thus, in one embodiment, the thickness of a reliably breakable copper antenna is between 0.5 and 9 microns. In the embodiment shown in FIG. 1A, the RFID tag antenna 103 is v-shaped, but it is noted that RFID tag antennas can be round, square, rectangular or any other shape known in the art.

The RFID tag antenna 103 is attached to an etched integrated circuit 102 that contains the logic for serial numbers and broadcasting to readers. The integrated circuit 102 can be attached to RFID tag antenna 103 by connectors (not shown) capable of carrying a signal to the RFID tag antenna 103. In one embodiment, connectors comprise conductors, for example made of the same material as the RFID tag antenna 103. Alternatively, integrated circuit 102 can be attached to RFID tag antenna 103 using semiconducting material. In some embodiments, these connectors are designed to break in response to a trigger event. These conductors can vary in length, but are preferably between a millimeter and several centimeters in length. The integrated circuit 102 may be in the same physical plane as the RFID tag antenna 103 or alternatively in a different physical plane.

The integrated circuit 102 is attached to the tag's energy receptor 101. The integrated circuit 102 can be attached to the energy receptor 101 via connectors 104. Connectors 104 are capable of carrying an electrical signal from the tag's energy receptor 101 to power the integrated circuit 102. Connectors 104 may comprise electrical leads of any conducting material such as copper, gold or aluminum or alternatively comprise semiconducting material. In some embodiments, these connectors are designed to break in response to a trigger event. Connectors 104 may comprise electrical leads that vary in length, but are preferably between a millimeter and several centimeters in length. The integrated circuit 102 may be in the same physical plane as the energy receptor 101 or alternatively in a different physical plane. In the embodiment of FIG. 1A, the energy receptor 101 is a metal coil. The magnetic field generated by a RFID reader induces a current in the metal coil that powers the RFID tag 100.

FIG. 1B shows the disablement of an RFID tag 100, according to one embodiment. The disablement of an RFID tag 100 may be accomplished by severing 105 the connectors 104 between the energy receptor 101 and the integrated circuit 102. Alternatively or additionally, disablement of an RFID tag 100 may be accomplished by breaking the connection between the integrated circuit 102 and the antenna 103. By severing the connection between the energy receptor 101 and the integrated circuit 102, the energy receptor 101 cannot power the integrated circuit. Thus, without power, the integrated circuit 102 cannot transmit a signal. Severing the connection between the integrated circuit 102 and the RFID tag antenna 103 also prevents the integrated circuit from transmitting a signal. Alternatively or additionally, disablement of an RFID tag 100 may be accomplished by destroying one or more components of the RFID tag 100 necessarily to transmit a signal or damaging one or more components to the extent that transmission of a signal is no longer possible. For example, disablement of an RFID tag 100 may be accomplished by damaging, disrupting, shorting out, or destroying the energy receptor 101, the integrated circuit 102 or the RFID tag antenna 103. By severing the connection between the energy receptor 101 and the integrated circuit 102 or the integrated circuit 102 and the antenna 103, or damaging, disrupting, shorting out, or destroying one or more components of the RFID tag 100 as described above, the RFID tag 100 is disabled. Alternatively or additionally, disablement of an RFID tag 100 may be accomplished by inserting a barrier between the RFID tag 100 and the RFID reader that prevents the RFID reader from reading the RFID tag. The barrier can be made of any blocking material of dimensions sufficient to prevent the RFID reader from reading the RFID tag 100. For example, in one embodiment, the barrier is a steel or lead lid that occludes RFID tag 100 from the reader. The disabled state of an RFID tag 100 can be remotely detected with an RFID reader when the RFID reader does not receive a signal from the tag during the next reading. Again, it is the ability to remotely detect the state of the RFID tag that allows the indication of the change in state of the object associated with the RFID tag to be perceived without direct visual examination of the object.

Referring now to FIG. 1C, in alternative embodiments, a triggering event reliably causes a tag to become enabled to transmit a signal. In FIG. 1C there is shown an arrangement of circuit components whereby a triggering event reliably causes a tag to become enabled to transmit a signal. In this example, power source 131 is used to power the integrated circuit of the first RFID tag 132, which is connected to RFID tag antenna 133, thus enabling the transmission of a signal. Power source 131 is also used to power an inverter circuit 150 through connection 153. Inverter circuit 150, also known in the art of electronics as a NOT circuit, may be comprised of any electrical components arranged so that if the input 151 is HIGH, the output 154 is LOW and vice versa. The methods of design and manufacture of inverter circuits suitable for use with RFID tags is known to those of ordinary skill in the art. In the example of FIG. 1C, power source 131 originally supplies power to integrated circuit 132 and the inverter circuit 150. The input 151 of inverter circuit 150 is HIGH when there is a connection between the power source 131 and the input 151. Because input 151 is HIGH, output 154 is LOW, and thus the integrated circuit of the second RFID tag 142 is not powered and is not capable of transmitting a signal. The components shown in FIG. 1C are associated with an object in such a way that a change of the state of the object causes a disconnection to occur at disconnect point 155. After a disconnection at this point occurs, input 151 to inverter circuit 150 is LOW, which means output 154 is HIGH, thus powering the integrated circuit of the second RFID tag 142 and enabling it to transmit a signal using RFID tag antenna 143. In this example, a change in state of the object causes the enablement of an RFID tag to transmit. Here, the first RFID tag continues to be able to transmit. In other alternative embodiments, the components shown in FIG. 1C could be arranged so that a change in state of the object causes a disconnection to occur instead at disconnection point 157 along the connection 156 between the power source and the integrated circuit of the first RFID tag 132. Then, upon the happening of the triggering event, the integrated circuit of the first RFID tag 132 would lose power, thus becoming disabled and the integrated circuit of the second RFID tag 142 would gain power, thus becoming enabled to transmit a signal. In this scenario, a triggering event may both disable transmissions from one RFID tag and enable transmissions from another RFID tag.

In the following examples, the change of state of an RFID tag is described as a change from being able to transmit a signal to not being able to transmit a signal for simplicity and ease of understanding. As described above with reference to FIG. 1C, it is also possible to implement systems and methods whereby the change in the state of the object results in a change in the state of the RFID tag from not being able to transmit a signal to being able to transmit a signal. Based on this description, one of ordinary skill the art will recognize that changing the state of the RFID signals from having one set of signal characteristics to a different set of signal characteristics is also possible.

To detect tampering with a product from the disablement of an RFID tag 100, the RFID tag 100 can be positioned so as to be secured to both sides of a juncture where the product is opened, or otherwise be exposed to tearing or damage at the point on the object where detection is desired. In one embodiment, one end of the RFID tag 100 is attached to one side of the juncture and the opposite end of the RFID tag 100 is attached to the other side of the juncture. In this way, the RFID tag 100 spans the seal of the product. The attachment of the ends of the RFID tag 100 on each side of the seal is preferably stronger than the weakest part of the RFID tag 100 spanning the seal. Therefore, the design of the RFID tags 100 predisposes the tag to break at a predetermined point rather than becoming unattached to one side or the other of the juncture when someone attempts to open the product. Examples of RFID tag placement so as to reliably break upon the happening of some event are described below.

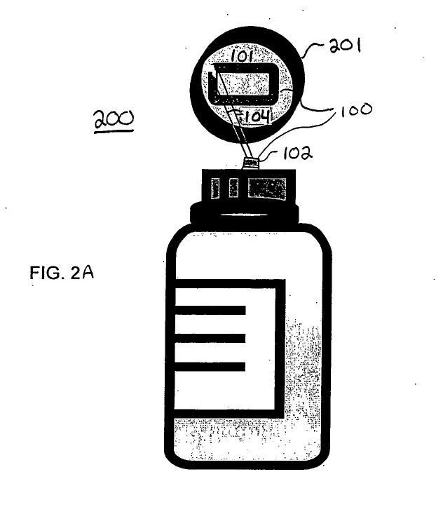

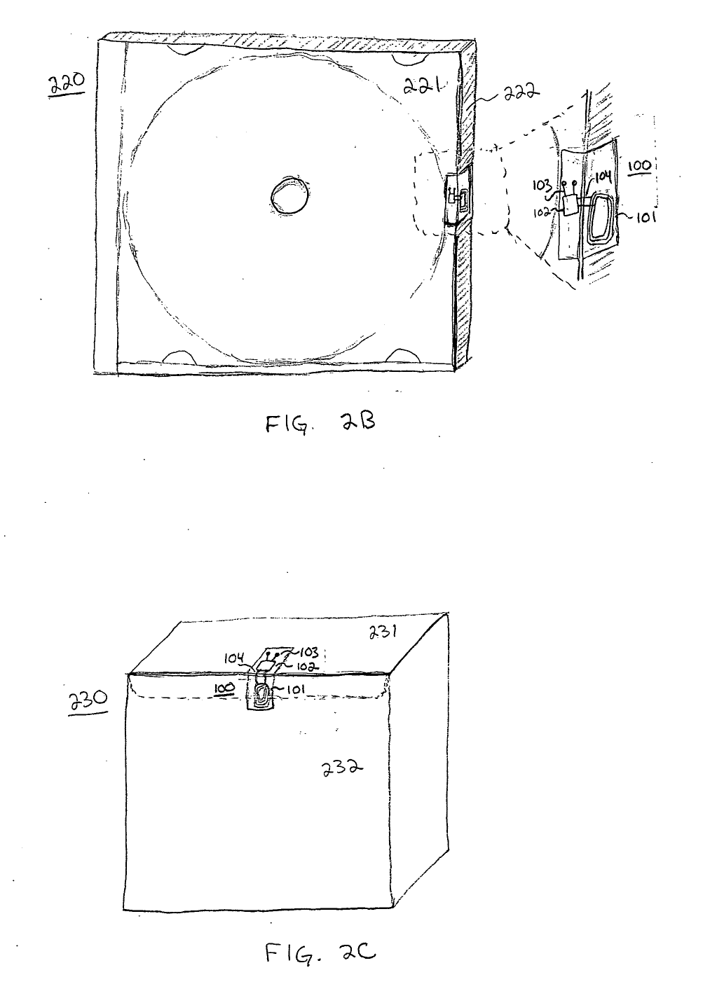

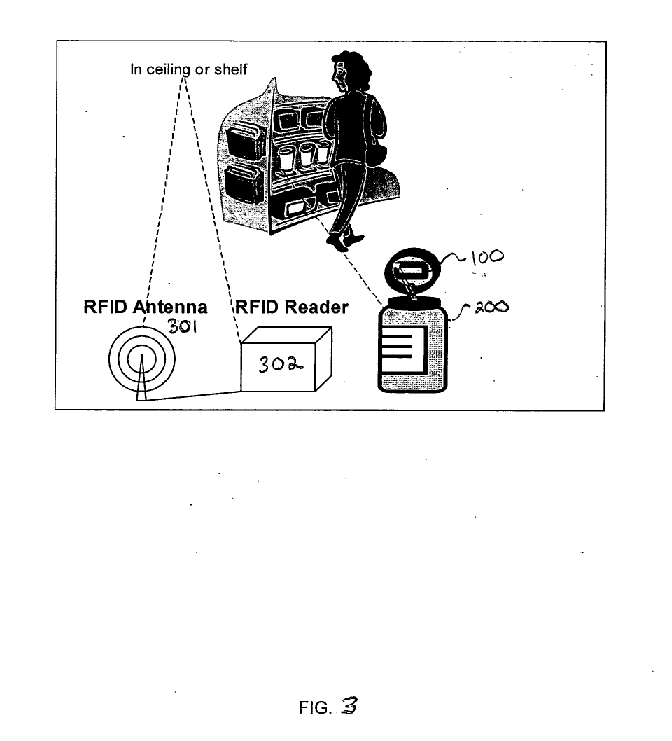

FIG. 2A shows the placement of an RFID tag on a bottle 200 to detect if the cap has been removed, according to one embodiment of the present invention. In this example, the integrated circuit 102 is affixed to the inside of the bottle 200, for example affixed to the inside of the neck of the bottle. In the example shown in FIG. 2A, the tag's energy receptor 101 is affixed to the bottle cap 201. When the bottle cap is removed, the connector 104 between the energy receptor 101 and the integrated circuit 102 is torn. Thus, the RFID tag 100 is disabled when the bottle cap is removed. Alternatively, the RFID tag can be affixed to the outside of the bottle, or be embedded in the material of the bottle or embedded in the traditional bottle seal ring around the outside of the bottle cap. Further alternatively, one part of the RFID tag 100 could be embedded in the traditional bottle seal ring around the outside of the cap, with the remainder of the RFID tag 100 inside the bottle. For example, RFID tag antenna 103 could be embedded in the seal ring and the remainder of the RFID tag 100 could be inside the bottle.

FIG. 2B shows the placement of an RFID tag 100 on a CD case 220 to detect if the CD case 220 has been opened, according to one embodiment of the present invention. In this example, the energy receptor 101 of the RFID tag 100 is affixed to the side 222 of the CD case 220 and the integrated circuit 102 and RFID antenna 103 are affixed to the front 221. In alternative embodiments, one or more RFID tags 100 can be placed across the seal of sealed cardboard, paper or plastic CD sleeves, jewel cases and the like. When the CD case 220 is opened, the connectors 104 break, disconnecting the energy receptor 101 and the integrated circuit 102. Thus, the RFID tag 100 is disabled when the CD case 220 is opened.

FIG. 2C shows the placement of an RFID tag 100 on a box 230 to detect if the box 230 has been opened, according to one embodiment of the present invention. In this example, the RFID tag 100 spans the juncture where the lid 231 of the box 230 lifts to open the box 230. The energy receptor 101 of the RFID tag 100 is affixed to the side 232 of the box 230 and the integrated circuit 102 and RFID antenna 103 are affixed to the top 231. When the box 230 is opened, the connectors 104 break, disconnecting the energy receptor 101 and the integrated circuit 102. Thus, the RFID tag 100 is disabled when the box 230 is opened. In alternative embodiments, one or more RFID tags 100 can be placed across the seal of any type of product enclosures including cardboard or plastic boxes, blister packs, and the like.

FIG. 6 shows the placement of an RFID tag 100 used as a document seal. The RFID tag 100 can be positioned, for example, to span the opening of a security envelope, either on the inside or outside of the envelope. The RFID tag 10 is positioned along the seal of a document such that the opening of the seal results in the disablement of the RFID tag 100. RFID tag 100 can also be placed across the opening of a book, manual, pamphlet, or other document to detect, for example, tampering with the product or opening it prior sale, or if it has been opened after sale in the case that the consumer wishes to return the product.

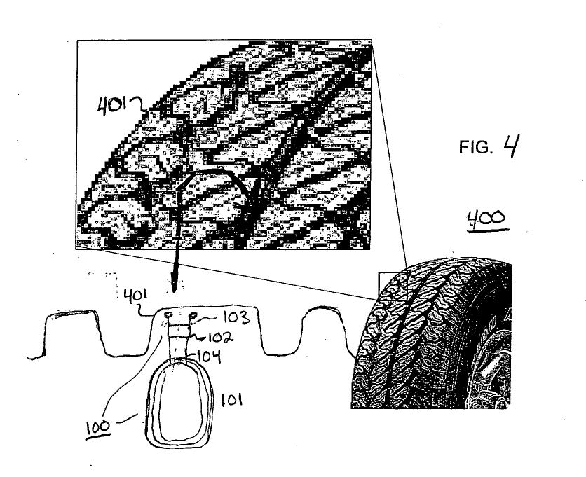

FIG. 3 shows an example of an RFID anti-tamper system, according to one embodiment of the present invention. The RFID anti-tamper system comprises an RFID tag 100 attached to a product, at least one RFID antenna 301 and an RFID reader 302. In the embodiment shown in FIG. 3, the RFID tag 100 is attached to a bottle 200. The bottle 200 is among the items on shelves in a store. At least one RFID antenna 301 is positioned within range of the RFID tag 100. RFID antennas 301 may be placed in the ceiling, floor, in the shelves, be free standing around the store and/or be contained in one or more mobile or handheld RFID readers. The RFID antenna 301 receives transmissions from RFID tags 100. The RFID antenna 301 is connected to an RFID reader 302 that interprets the transmissions from the RFID tags 100. In some embodiments, the RFID reader 302 is a computer system capable of processing the signals received from the RFID tags 100, storing the information, and alerting users if a tag becomes unreadable. The RFID reader can further be configured to output the identification of any tag that becomes unreadable, such as when bottle 200 is opened in the store and the RFID tag 100 breaks.

FIG. 4 shows the placement of an RFID tag 100 embedded in a tire 400 to detect tread 401 wear. The RFID tag 100 can be vertically embedded in the tire, for example. As the tire tread 401 wears down, the RFID tag 100 is exposed. The RFID tag 100 can be positioned so that one or more components of the RFID tag 100 will be destroyed through contact with the road surface at or near the level of tread wear that indicates that the tire should be replaced. Alternatively, the RFID tag can be positioned so that the connection between two components, such as the energy receptor 101 and the integrated circuit 102, becomes exposed and will be torn through contact with the road surface at or near the level of tread wear that indicates that the tire should be replaced. Further alternatively, multiple RFID tags can be positioned at increasing depths in the tire tread so that the disablement of each tag indicates an increased level of wear.

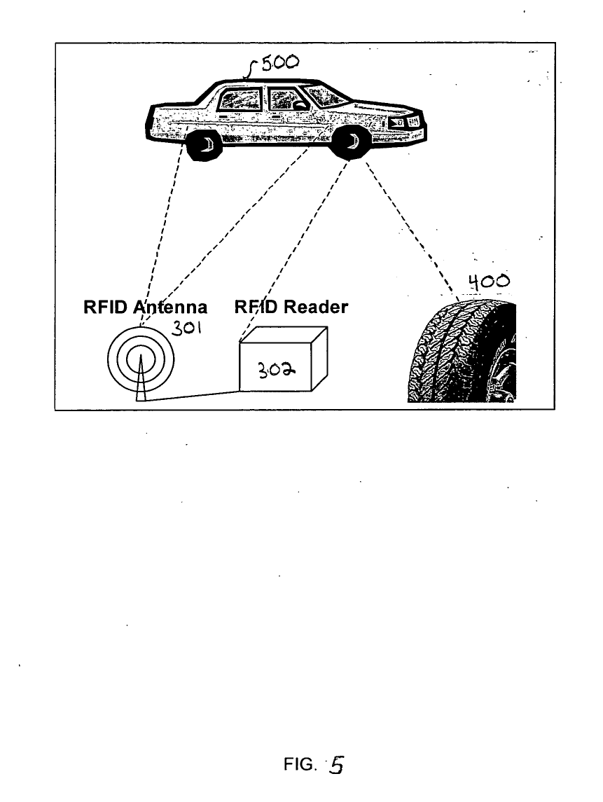

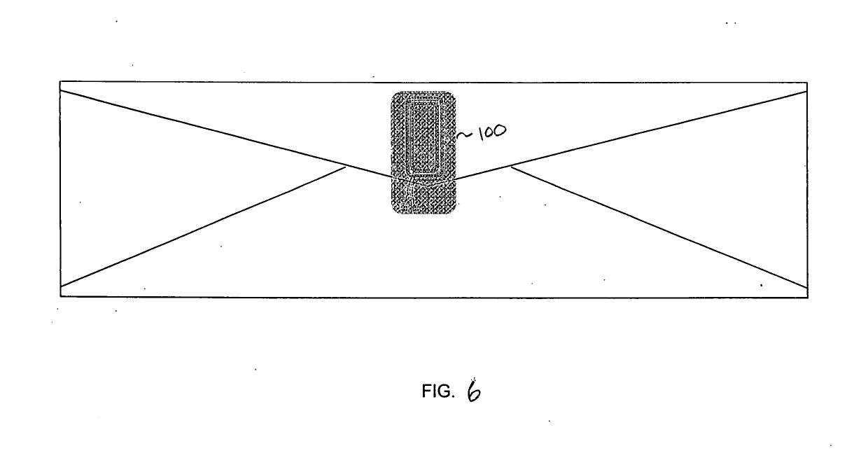

FIG. 5 shows an example of an RFID disablement detection system, according to one embodiment of the present invention. As in the example shown in FIG. 3, this example system comprises at least one RFID tag, at least one RFID antenna, and an RFID reader. The RFID tags are embedded in the tires 400 of a vehicle 500. The RFID antennas 301 of the RFID disablement detection system are positioned to be able to read the RFID tags in places appropriate for the context of the purpose of the system. For example, RFID antennas 301 in this example can be located in the car, located in the surface upon which the tire travels, in or around automobile related businesses such as gas stations and repair shops. The RFID antennas 301 are coupled to one or more RFID readers 302, as described above. The RFID reader 302 can be configured to output the identification of any tag that has been disabled. Thus, the user of this system can be notified when a tag has been disabled, indicating tire replacement is warranted due to tread wear. Alternatively, where multiple RFID tags have been embedded in the tread of a tire, an RFID disablement detection system can also be implemented to output notification of uneven tread wear. If an RFID reader detects that one or more RFID tags have been disabled in a particular area of the tire, the user of the system can be notified that tire rotation is warranted due to tread wear.

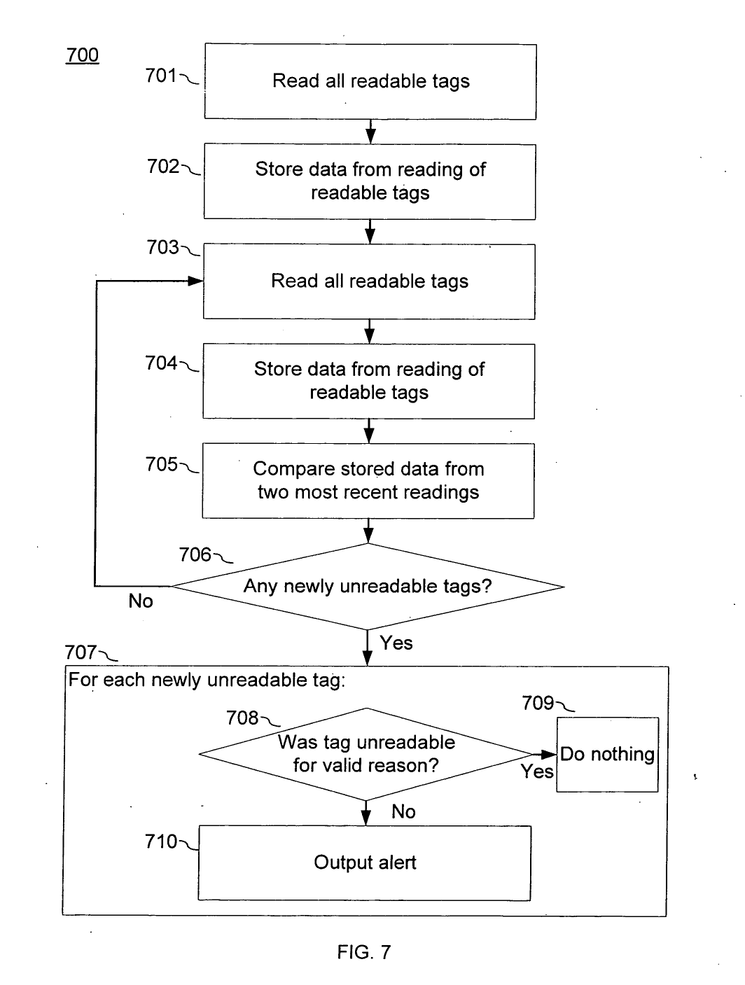

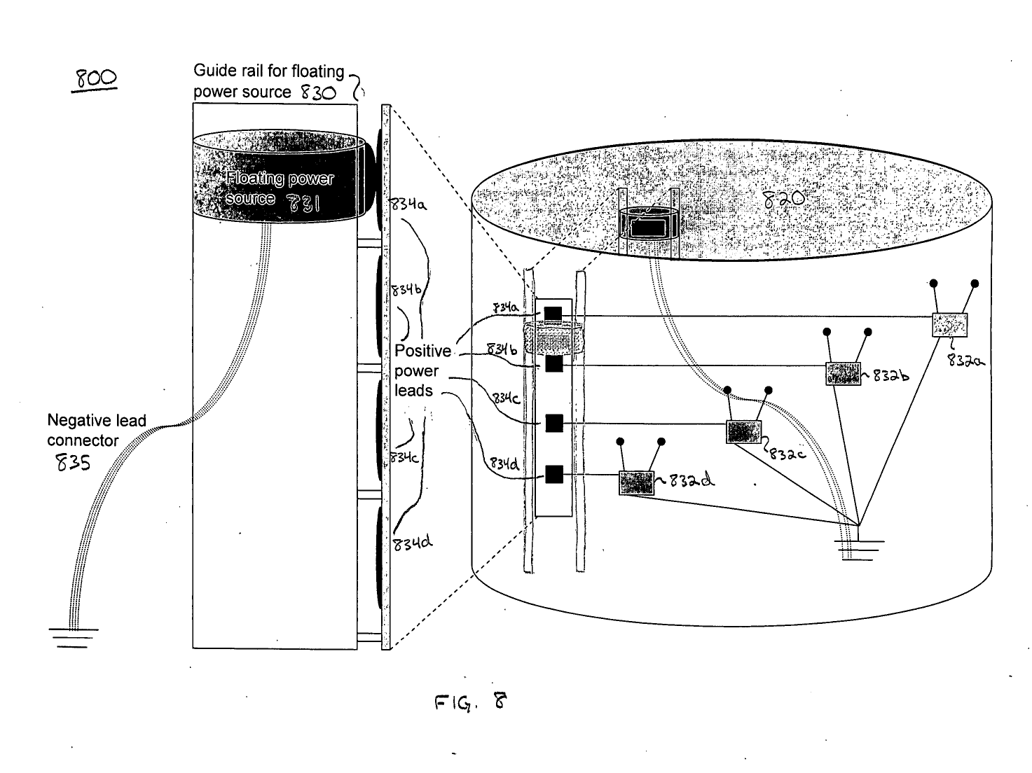

FIG. 7 shows a sample method 700 to detect RFID tag disablement, according to an embodiment of the present invention. In the first step, all readable tags are read 701, for example using RFID reader 302. This first read of all readable tags can be used to establish a baseline from which all changes will ultimately be recorded. RFID reader 302 can read all tags that are within range of the RFID antenna 301 that are not disabled. In some embodiments, the data collected from the reading of the readable tags is stored 702 in a database. The data recorded can include the serial number or other identifying information of every readable tag, and the date and time of the read. In some embodiments, there is a one to one relationship between tags and products. In other embodiments, only some of a group of products are equipped with RFID tags, such as when RFID tags have been applied to a random sample of products. In other embodiments, one tag may correspond to a group of products, such as when the tag is applied to the outer packaging of individual units. In some embodiments, the data recorded from the reading of the readable tags can be correlated to other data stored in product databases. Then all readable tags are read 703 again. The elapsed time between readings of the readable tags can be configured to be appropriate to the specific implementation of the system. For example, in a rapidly changing environment, it is preferred to read tags more frequently to keep information fresh. In these cases, the RFID reader can be configured to conduct readings multiple times per second. In other environments, updates may be desired only hourly, daily, or even less frequently.

In step 705, the data stored from the two most recent readings are compared. From this comparison, it can be determined 706 if there are any newly unreadable tags. Newly unreadable tags are those tags that were read in the second most recent reading but not read in the most recent reading. If there are no newly unreadable tags, the method 700 returns to another reading 703 of the readable tags. If there is at least one newly unreadable tag, then for each newly unreadable tag, the method 700 completes the steps within box 707 of FIG. 7. For each newly unreadable tag, it is determined 708 whether the tag was unreadable for a valid reason by checking against a record of events that would result in the valid disablement of a tag or the movement of a tag outside of the range of the RFID reader 302. Examples of valid reasons in the context of a grocery store are a purchase of the item and a move of the item to offsite storage. Valid reasons for a tag to become unreadable can be tracked by the system. For example, in some embodiments, the system records when a tag has passed through the checkout system. Thus, although the tag is no longer among the readable tags read by the RFID reader 302 in the store, this is due to a valid reason and not due to product tampering. If a tag is unreadable for a valid reason, then no action is required 709. If the tag has not become unreadable for a valid reason, then an alert is output 710 to notify personnel that an invalid disablement of a tag has occurred. For example, if no RFID antenna 301 is receiving a signal from the tag and the tag has not passed through the checkout system within a reasonable time, then the RFID reader 302 or a computer system linked to the RFID reader 302 will then alert personnel that a tag has been disabled, but has not left the store. Alternatively or additionally, at check-out, the system could alert checkout personnel that a tag is unreadable on a scanned item and that the personnel should check the item for tampering.

The above examples illustrate several embodiments of the present invention in detail with reference to the figures. The present invention is also suitable for use in other contexts, without departing from the principles of the invention, as will be described briefly below.

Medicine packs in nursing homes. In one embodiment, RFID tags are used to monitor the dispensing of medication by nursing home employees to nursing home residents. Pharmaceutical companies provide doses of medications for residents in single dose tear-off blister packs to nursing home employees. RFID tags can be positioned to span the location where an employee tears off the dose. An RFID tag detection system can then detect when a tag is disabled by tearing off a dose, which enables monitoring by a doctor or pharmaceutical company of when medications are dispensed by employees. The system can also detect when inventory is running low and alert personnel to order additional stock. Alternatively, the system can be configured to directly alert a doctor or a pharmaceutical company that supplies are dwindling.

Paper seals. In one embodiment, RFID tags are used to ensure that paper seals have not been compromised. For example, RFID tags can be embedded in the paper money holders so that the RFID tag is disabled when the bills are separated from the stack and used. Thus, an anti-tamper RFID tag indicates when the bills are separated, preventing replacing internal bills in the stack with bills of smaller denominations. As another example, anti-tamper RFID tag can be embedded in the paper seals used to seal test booklets. If a test-taker tears open the booklet prior to the start of the examination, the RFID tag would indicate which test taker started the examination early. A tracking system could also indicate exactly when each test-taker began the examination.

Security Tape. In one embodiment, RFID tags are embedded in security adhesive tape. The security adhesive tape can then be placed across a span, such as between a door and the door jam, such that the opening of the door disables the RFID tag. This security adhesive tape could be used to indicate if the door to a home, or car, or safe, or safety deposit box, or the like has been opened.

Wine Corks. In one embodiment, an RFID tag is attached to a wine bottle and cork such that the opening of the wine bottle disables the RFID tag. For example, an RFID tag detection system in a restaurant can determine if a bottle has been opened, and thus is of less value, or if an opened bottle is present that should be used prior to opening other bottles.

Security luggage seal. In one embodiment, an RFID tag is placed on searched luggage at an airline baggage screening facility after the luggage has been searched so that any opening of the bag results in the disablement of the tag. Thus, the disablement of the RFID tag indicates that a previously searched bag has been opened.

Car odometers and sealed devices under warranty. Modifying certain devices, such as car odometers, is against the law. Modifying other devices, such as those under warranty, voids the warranty. In one embodiment, an RFID tag is affixed to the device such that the opening of the device results in the disablement of the RFID tag. In these situations, an RFID tag reader could be used to determine if the odometer or other device has been opened. For example, a repair shop could detect the broken seal using an RFID tag reader, rather than disassembling the product to visually inspect the seal.

Environmental suits. In one embodiment, RFID tags are affixed to environmental suits worn by personnel such that an RFID tag is disabled if a tear has occurred that compromises the integrity of the suit. Thus, an RFID tag system can alert personnel of the tear and safety risk even if it is not visually apparent. Furthermore, multiple tags could be positioned in suit material or on the suit material such that the number of disabled tags indicates the severity of the tear.

SCUBA o-ring and other gaseous container seals. In one embodiment, RFID tags are affixed to the container seals such that a disablement of the RFID tag indicates a breakdown in the seal. For example, one or more embedded RFID tags can be placed so that a connection between components spans the maximum distance around the ring seal. In this example, when the connection between the components of the RFID tag is broken, it indicates a failure in the seal.

Differentiating New and Used Products. In one embodiment, an RFID tag is used to differentiate between truly new products and used products that have been resealed so as to appear new. To determine if a used product has been resealed with an RFID tag to appear new, a comparison is made between the RFID tag on the used product, and the RFID tag originally associated with the product by the manufacturer. Whereas new products will retain their original RFID tag, used products that have been resealed with an RFID tag so as to appear new will not. Any discrepancy between the expected RFID tag from the manufacturer and the RFID tag actually affixed to the product means the product is used.

Liquid in containers. In one embodiment, RFID tags are used to detect how much liquid remains inside of a container. FIG. 8 shows an example implementation of a system 800 for determining how much liquid resides in a container 820 using RFID tags 832a-d, according to one embodiment of the present invention. Positive power leads 834a-d to each of several RFID tags 832a-d are placed at various depths along the inside of a container 820 holding liquid contents. A floating power source 831 floats in the liquid inside the container 820 constrained by the guide rail 830 for the floating power source 831. The guide rail 830 could be sealed against liquid intrusion in some embodiments by using a waterproof curtain (not shown) attached at the top and bottom of the floating power source 831. The negative lead connector 835 of the floating power source 831 is grounded. As the level of contents increases or decreases inside the container 820, the floating power source rises or falls, respectively. When the level of liquid changes enough, the floating power source 831 will cease making a connection with one positive power lead, for example 834a, and begin making a connection with another positive power lead, for example 834b. When floating power source 831 is connected to a positive power lead 834a-d, the corresponding RFID tag 832a-d is able to transmit a signal. When floating power source 831 is not connected to the positive power lead 834a-d corresponding to the RFID tag 832a-d, the RFID tag 832a-d is not able to transmit a signal. Thus, an RFID reader positioned to receive signals from an RFID tag 832a-d can be used to determine the level of the liquid inside the container 820 without visual inspection of the container 820 or its contents. FIG. 8 shows an embodiment using four RFID tags 832a-d. Alternatively, more or fewer RFID tags can be used. In one embodiment, only one positive power lead 834a to one RFID tag 832a is placed so as to be connected to the floating power source 831, thus enabling transmission, when a refill of the container is needed.

Force sensors. In one embodiment, RFID tags are used to detect the amount of force applied to a force sensor. As the amount of force applied to one or more force sensors attached to power sources and/or integrated circuits changes, power flows through different leads which correspond to different RFID tags. In this embodiment, an RFID reader can then determine from which RFID tag or tags are transmitting the weight of material either remaining or missing. In one embodiment, this system can be built into storage or display devices or apparatus and used for inventory tracking purposes to measure even very small weight differences.

What is claimed is:

1. A device for signaling a change in state of an object, the device comprising:
a radio frequency identification tag; and
a component for disabling the radio frequency identification tag responsive to a change in state of the object.

2. The device of claim 1, wherein the radio frequency identification tag comprises an antenna and wherein the component for disabling the radio frequency identification tag disables the antenna.

3. The device of claim 1, wherein the radio frequency identification tag comprises an integrated circuit and wherein the component for disabling the radio frequency identification tag disables the integrated circuit.

4. The device of claim 1, wherein the radio frequency identification tag comprises an energy receptor and wherein the component for disabling the radio frequency identification tag disables the energy receptor.

5. The device of claim 1, wherein the radio frequency identification tag comprises a power source and wherein the component for disabling the radio frequency identification tag disables the power source.

6. The device of claim 1, wherein the radio frequency identification tag comprises an antenna, an integrated circuit, and an energy receptor, and wherein the component for disabling the radio frequency identification tag disconnects at least one of the antenna, the integrated circuit, and the energy receptor.

7. The device of claim 1, wherein the radio frequency identification tag comprises an integrated circuit and a power source, and wherein the component for disabling the radio frequency identification tag disconnects the power source from the integrated circuit.

8. The device of claim 1, wherein the change in state of the object is one selected from the group consisting of an unsealing, an opening, an unattachment, a level of wear, and a level of contents.

9. The device of claim 1, wherein the object comprises a container and wherein the component disables the RFID tag responsive to the container being opened.

10. The device of claim 1, wherein the object comprises a product packaging and wherein the component disables the RFID tag responsive to the product packaging being opened.

11. The device of claim 1, wherein the object comprises a CD case and wherein the component disables the RFID tag responsive to the CD case being opened.

12. The device of claim 1, wherein the object comprises a tire and wherein the component disables the RFID tag responsive to the tire attaining a level of wear.

13. The device of claim 1, wherein the radio frequency identification tag is affixed to the object.

14. The device of claim 1, wherein the component comprises a portion of the object.

15. A device for signaling a change in state of an object, the device comprising:
a radio frequency identification tag; and
a component for enabling the radio frequency identification tag responsive to a change in state of the object.

16. The device of claim 15, wherein the radio frequency identification tag comprises an antenna and wherein the component for enabling the radio frequency identification tag enables the antenna.

17. The device of claim 15, wherein the radio frequency identification tag comprises an integrated circuit and wherein the component for enabling the radio frequency identification tag enables the integrated circuit.

18. The device of claim 15, wherein the radio frequency identification tag comprises an energy receptor and wherein the component for enabling the radio frequency identification tag enables the energy receptor.

19. The device of claim 15, wherein the radio frequency identification tag comprises a power source and wherein the component for enabling the radio frequency identification tag enables the power source.

20. The device of claim 15, wherein the radio frequency identification tag comprises an antenna, an integrated circuit, and an energy receptor, and wherein the component for enabling the radio frequency identification tag connects at least one of the antenna, the integrated circuit, and the energy receptor.

21. The device of claim 15, wherein the radio frequency identification tag comprises an integrated circuit and a power source, and wherein the component for enabling the radio frequency identification tag connects the power source and the integrated circuit.

22. The device of claim 15, wherein the change in state of the object is one selected from the group consisting of an unsealing, an opening, an unattachment, a level of wear, and a level of contents.

23. The device of claim 15, wherein the object comprises a container and wherein the component enables the RFID tag responsive to the container being opened.

24. The device of claim 15, wherein the object comprises a product packaging and wherein the component enables the RFID tag responsive to the product packaging being opened.

25. The device of claim 15, wherein the object comprises a CD case and wherein the component enables the RFID tag responsive to the CD case being opened.

26. The device of claim 15, wherein the object comprises a tire and wherein the component enables the RFID tag responsive to the tire attaining a level of wear.

27. The device of claim 15, wherein the radio frequency identification tag is affixed to the object.

28. The device of claim 15, wherein the component comprises a portion of the object.

29. A method of detecting a change in state of an object, the method comprising:
receiving a signal from a radio frequency identification tag; and
receiving an indication that the radio frequency identification tag has been disabled responsive to a change in state of the object.

30. The method of claim 29, wherein the radio frequency identification tag comprises an antenna and wherein disabling the radio frequency identification tag comprises disabling the antenna.

31. The method of claim 29, wherein the radio frequency identification tag comprises an integrated circuit and wherein disabling the radio frequency identification tag comprises disabling the integrated circuit.

32. The method of claim 29, wherein the radio frequency identification tag comprises an energy receptor and wherein disabling the radio frequency identification tag comprises disabling the energy receptor.

33. The method of claim 29, wherein the radio frequency identification tag comprises a power source and wherein disabling the radio frequency identification tag comprises disabling the power source.

34. The method of claim 29, wherein the radio frequency identification tag comprises an antenna, an integrated circuit, and an energy receptor, and wherein disabling the radio frequency identification tag comprises disconnecting at least one of the antenna, the integrated circuit, and the energy receptor.

35. The method of claim 29, wherein the radio frequency identification tag comprises an integrated circuit and a power source, and wherein the disabling the radio frequency identification tag comprises disconnecting the power source from the integrated circuit.

36. The method of claim 29, wherein the change in state of the object is one selected from the group consisting of an unsealing, an opening, an unattachment, a level of wear, and a level of contents.

37. The method of claim 29, wherein the object comprises a container and wherein receiving an indication that the radio frequency identification tag has been disabled is responsive to the container being opened.

38. The method of claim 29, wherein the object comprises a product packaging and wherein receiving an indication that the radio frequency identification tag has been disabled is responsive to the product packaging being opened.

39. The method of claim 29, wherein the object comprises a CD case and wherein receiving an indication that the radio frequency identification tag has been disabled is responsive to the CD case being opened.

40. The method of claim 29, wherein the object comprises a tire and wherein receiving an indication that the radio frequency identification tag has been disabled is responsive to the tire attaining a level of wear.

41. The method of claim 29, wherein the radio frequency identification tag is affixed to the object.
